(19) United States
(12) Patent Application Publication
(10) Pub. No.: US 2006/0230001 A1
(43) Pub. Date: Oct. 12, 2006

(54) Postage meter for optimizing the printing quality of sensitive data printed on a mail item

(75) Inventor: Sebastien Defosse, Le Plessis Robinson (FR)

Correspondence Address: SUGHRUE MION, PLLC, 2100 PENNSYLVANIA AVENUE, N.W., SUITE 800, WASHINGTON, DC, 20037, US

(73) Assignee: NEOPOST Technologies

(21) Appl. No.: 11/341,587

(22) Filed: Jan. 30, 2006

(30) Foreign Application Priority Data
Jan. 31, 2005 (FR) 05 00933

(51) Int. Cl. G06F 17/00

(52) U.S. Cl. 705/408

(57) ABSTRACT

This postage meter includes means for presetting the position of the print head so that sensitive information is printed on a mail item at a time when said item is not being subjected to any jolting.

### BACKGROUND OF THE INVENTION

The present invention relates to the general field of mail handling, and relates more particularly to a postage meter or “franking machine”.

Document EP 0 724 234 describes a postage meter in which the mail items are conveyed by pairs of rollers placed in succession from upstream to downstream of a print head.

More precisely, and in particular to avoid any slippage, the mail item is nipped at various places in the meter, e.g. between a roller and an associated platen or backing roller that are disposed facing each other.

The person skilled in the art can understand that, at each of those nips, the mail item is subjected to a slight jolt so that, in practice, the mail item does not travel along its path at constant speed. When bulk-handling mail items that are of various thicknesses, such jolts can be particularly large and unpredictable.

In certain configurations, such a jolt can occur while data is being printed on the mail item, which can be highly detrimental if the data being printed during the jolt requires high precision.

That applies in particular when such data is constituted by a “fingerprint” serving to be read back subsequently and automatically for the purposes of verifying or authenticating the mail item.

### OBJECT AND SUMMARY OF THE INVENTION

A main object of the present invention is thus to mitigate such drawbacks. To this end, it provides a postage meter having conveyor means adapted to move a mail item into register with a stationary print head during printing, and then towards extractor means for extracting said mail item. Said postage meter includes means for presetting the position of the print head so as:

either to finish printing sensitive information on said mail item before said mail item reaches said extractor means;

or to wait until said mail item is stabilized by said extractor means before starting to print said sensitive information.

This postage meter thus makes it possible to guarantee that the mail item is not subjected to any jolting while the sensitive data is being printed because either the printing is finished before the mail item reaches the extractor means, or the printing is deferred until the mail item is stabilized by said extractor means.

In the invention, the postage meter includes means for presetting the position of the print head so as to satisfy at least one of those conditions, as a function of the position of the sensitive data on the envelope.

The presetting can be performed manually.

But preferably, the postage meter includes means for selecting said preset position from among a plurality of predetermined positions stored in a non-volatile memory of said meter.

In preferred manner, the postage meter includes means for automatically defining said predetermined position on the basis of selection of a place of use of said meter. The position of the sensitive data on the envelope depends mainly on the postal legislations of the various countries. Thus, on installing the postage meter, it is possible to use a customization menu in which the user enters a country of use, the print head then being positioned such that the printing of the sensitive data for that country is performed at a time at which the mail item is not being subjected to any jolting.

In a preferred embodiment, the extractor means are constituted by two mutually-facing elements, at least one of the elements being suspended, so as to make it possible to frank mail items that are of different thicknesses.

This embodiment advantageously makes it possible to handle mail in bulk, whereas, conventionally, it is extremely difficult to print sensitive data on bulk-handled mail.

The sensitive data in question may, in particular be a fingerprint serving to be read back subsequently, e.g. by a scanner, for the purposes of checking information, e.g. enciphered information, contained in said fingerprint.

### BRIEF DESCRIPTION OF THE DRAWINGS

Other characteristics and advantages of the present invention appear more clearly from the following description given with reference to the accompanying drawings which show an embodiment that is in no way limiting, and in which:

FIG. 1 diagrammatically shows a mail item that can be handled by a postage meter of the invention;

FIGS. 2A and 2B show the mail item of FIG. 1 in a postage meter of the invention, in a first embodiment, prior to printing the sensitive data, and in respective ones of two positions;

FIG. 2C shows the mail item in the meter of FIG. 2A at the end of printing of the sensitive data;

FIG. 3 shows the position of the mail item of FIG. 1 in a second embodiment of a postage meter of the invention, prior to printing the sensitive data; and

FIG. 4 shows control means for controlling the postage meters of FIGS. 2A to 3.

### DETAILED DESCRIPTION OF AN EMBODIMENT

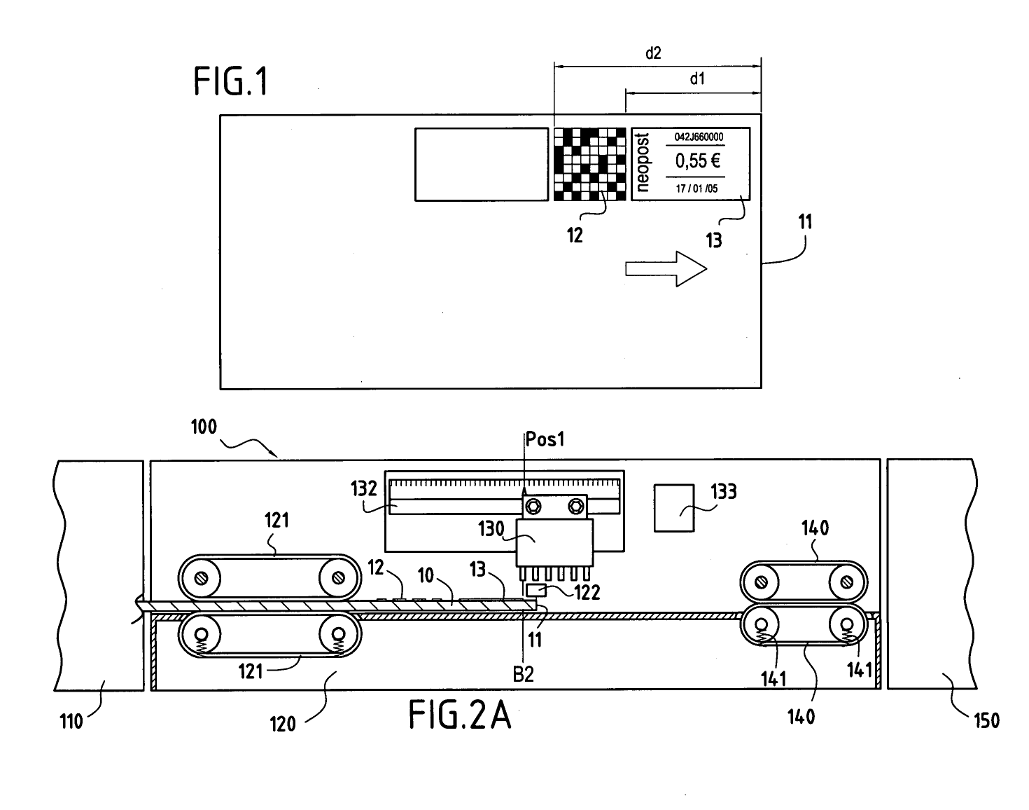

FIG. 1 shows a mail item 10, e.g. an envelope.

In known manner, said envelope has a plurality of zones including a stamp zone 13 and zone referenced 12 serving to receive sensitive data.

In the example described herein, the sensitive data 12 is constituted by a two-dimensional bar code. In another variant embodiment, said sensitive data can be constituted by a fingerprint that stores enciphered data serving to authenticate the mail item 10.

Below:

let d1 be the distance between the start of the sensitive zone 12 and the leading edge 11 of the envelope; and

let d2 be the distance between the end of the sensitive data zone and the leading edge 11 of the envelope.

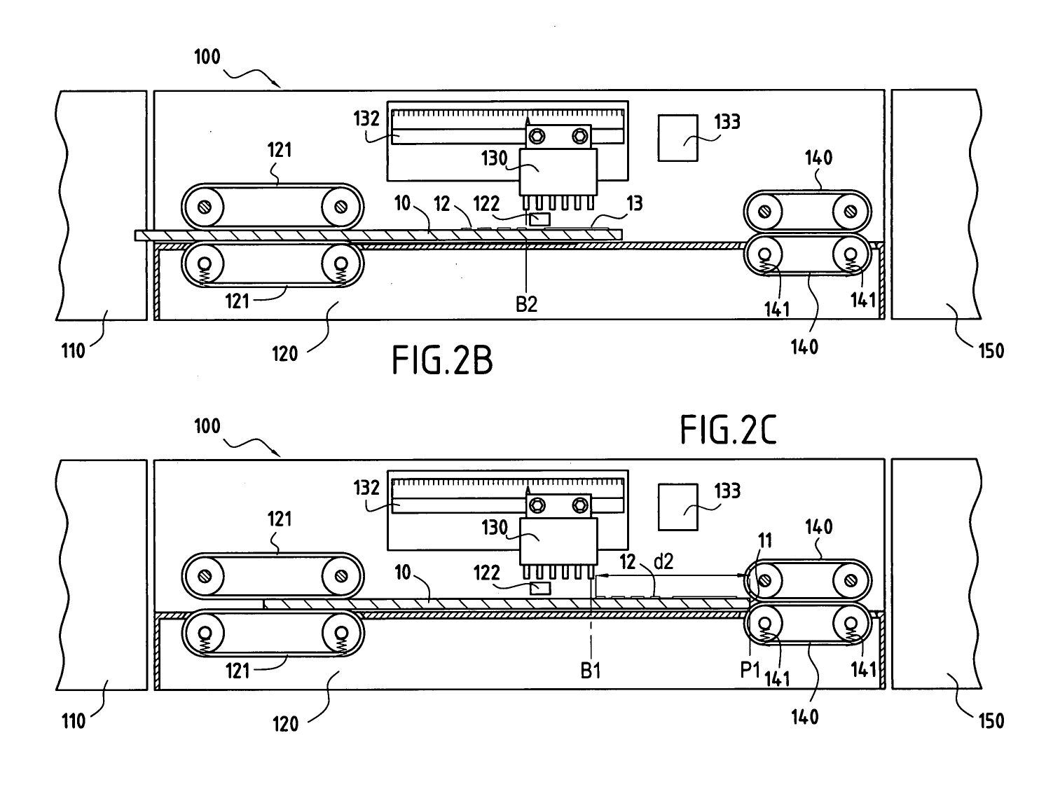

FIG. 2A shows a first embodiment of a postage meter 100 of the invention.

This postage meter 100 comprises a feed module 110, a franking module 120, and a storage module 150.

In the embodiment shown in FIG. 2A, the mail item 10 is conveyed inside the franking module 120 by two facing belts 121 placed upstream from the print head 130.

After printing, the mail item is extracted by extractor means 140 constituted by two facing belts inside the same franking module 120.

In this embodiment, the bottom belt 140 is suspended on springs 141 to enable mail items 10 of different thickness to be extracted.

In the preferred embodiment described herein, the postage meter 100 is provided with a sensor 122 adapted to sense the leading edge 11 of the envelope 10.

The postage meter 100 is also provided with control means 133, some elements of which are shown in FIG. 4. The control means 133 include, in particular, a processor 137 that is connected to a memory 136, to a keypad 134, and to a screen 135 by a bus system.

The processor 137 is, in particular, adapted to start printing data on the mail item 10 on receiving a signal from the sensor 122 indicating that the leading edge 11 of the envelope 10 has been detected.

In the invention, the postage meter 100 is provided with means for pre-setting the position of the print head 130.

In the preferred embodiment described herein, said means are constituted by a rail 132 along which the print head 130 is mounted to move to a position Pos 1 received from the processor 137.

In the preferred embodiment described herein, the memory 136 contains a table T which, for various countries, FR, GB, IT, XX, stores the following three items of information:

d1: distance between the start of the sensitive data zone 12 and the leading edge 11 of the envelope;

d2: distance between the end of the sensitive data zone 12 and the leading edge 11 of the envelope; and

Pos: position of the print head that makes it possible to guarantee that the sensitive data 12 is printed at a time at which the mail item 10 is not subjected to any jolting.

FIG. 2A shows the mail item 10 at the time at which the upstream-most nozzle B2 of the print head 130 starts to print non-sensitive data (the stamp 13) on the envelope.

FIG. 2B shows the mail item 10 at the time at which the nozzle B2 starts printing the sensitive data 12 on the envelope 10.

FIG. 2C shows the mail item 10 just after the end of printing of the sensitive data 12 by the downstream-most nozzle B1 of the print head 130.

FIG. 2C shows that the sensitive data 12 is printed in full before the mail item 10 reaches the extractor means 140. This is guaranteed because the position POS1 of the print head 130 is such that the distance between the downstream-most nozzle B1 and the point P1 of first contact between the mail item 10 and the extractor means 140 is greater than the distance d2 between the trailing edge of the sensitive data 12 and the leading edge 11 of the envelope.

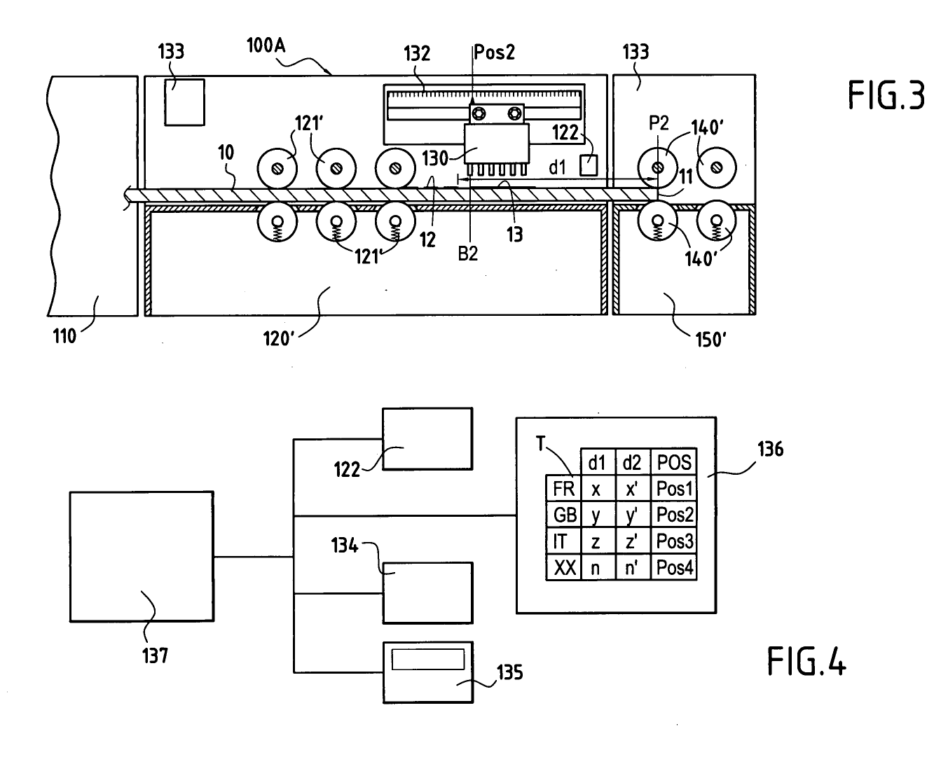

FIG. 3 shows another embodiment of a postage meter 100A of the invention.

In this embodiment, the extractor means 140′ adapted to nip the mail item 10 after the printing are situated in a storage module 150′.

In the example described herein, the conveyor means 121′ and the extractor means 140′ are constituted by pairs of rollers, each pair comprising a roller and a backing roller facing each other, the bottom rollers being suspended so as to enable mail items that are of different thicknesses to be conveyed and extracted.

The overall size of this postage meter 100A is such that it is not possible to satisfy the condition of the postage meter of FIGS. 2A and 2B, the distance between the downstream-most nozzle B1 and the first point of contact P1 of the extractor means 140″ being smaller than the distance d2.

However, this postage meter 100A makes it possible to guarantee that the sensitive data 12 is printed at a time at which the mail item 10 is not subjected to any jolting.

In this embodiment, printing can start only once the mail item 10 is fully stabilized by the extractor means 140′, i.e. once the leading edge 11 of the mail item has reached the point of contact P2 corresponding to the end of adaptation of the extractor means for the purpose of accommodating the thickness of said mail item.

This constraint is satisfied when the distance between the downstream-most nozzle B2 of the print head 130 and said point of contact P2 is less than the distance d1 between the start of the sensitive zone 12 and the leading edge of the envelope 11.

This condition is satisfied by moving the print head 130 to the position Pos 2 along the rail 132.

In the preferred embodiment described herein, each of the postage meters 100 and 100A has a keypad making it possible to select the country FR, GB, IT, XX in which the meter is used, and a screen 135 for verifying the selection.

Once the selection has been made, the processor 137 reads off the position Pos 1, Pos 2 associated with the country in the table T and causes the print head 130 to move along the rail 132 to said position.

What is claimed is:

1. A postage meter having conveyor means adapted to move a mail item into register with a stationary print head during printing, and then towards extractor means for extracting said mail item, said postage meter including means for presetting the position of the print head so as:
either to finish printing sensitive information on said mail item before said mail item reaches said extractor means;
or to wait until said mail item is stabilized by said extractor means before starting to print said sensitive information.

2. A postage meter according to claim 1, including means for selecting said preset position from among a plurality of predetermined positions stored in a non-volatile memory of said meter.

3. A postage meter according to claim 1, including means for automatically defining said predetermined position on the basis of selection of a place of use of said meter.

4. A postage meter according to claim 1, wherein said extractor means are constituted by two mutually-facing elements, at least one of the elements being suspended, so as to make it possible to frank mail items that are of different thicknesses.

5. A postage meter according to claim 1, wherein said sensitive information is a fingerprint serving to be read back subsequently for the purposes of checking information contained in said fingerprint.
